(19) United States
(12) Patent Application Publication
(10) Pub. No.: US 2008/0002280 A1
(43) Pub. Date: Jan. 3, 2008

(54) Method and apparatus for head positioning control in a disk drive

(75) Inventor: Makoto Asakura, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/819,406

(22) Filed: Jun. 27, 2007

(30) Foreign Application Priority Data
Jun. 30, 2006 (JP) 2006-182657

(51) Int. Cl. G11B 5/00

(52) U.S. Cl. 360/76

(57) ABSTRACT

According to one embodiment, a disk drive having a disk medium of DTM structure has a control processing unit which performs positioning control to position a write head on a designated data track on the disk medium in data recording. The control processing unit performs the positioning control in accordance with a recording target offset amount which is calculated by adding a first offset amount depending on the skew angle and a second offset amount set for each servo sector.

### CROSS-REFERENCE TO RELATED APPLICATIONS

This application is based upon and claims the benefit of priority from Japanese Patent Application No. 2006-182657, filed Jun. 30, 2006, the entire contents of which are incorporated herein by reference.

### BACKGROUND

1. Field

One embodiment of the present invention generally relates to a disk drive, such as a disk drive having a disk medium having, for example, a discrete track medium structure.

2. Description of the Related Art

Generally, in disk drives such as hard disk drives, head positioning control for positioning the head in a target position on a disk medium is performed by using servo data recorded on the disk medium. The servo data is recorded on a disk medium by a servo track writer, which is a dedicated device, in a servo writing step included in manufacturing process of disk drives.

In recent years, disk medium having a structure called discrete track medium (DTM: hereinafter referred to as DTM structure) have received attention. Disk medium having DTM structure have regions effective as magnetic recording portions and ineffective regions, which are formed on a surface thereof. The effective regions are projecting magnetic regions provided with a magnetic film. On the other hand, the ineffective regions are non-magnetic regions, or depressed regions in which magnetic recording cannot be performed. Specifically, the ineffective regions are portions which are substantially formed as non-magnetic regions since they are depressed, even when they are provided with a magnetic film.

Disk medium having the above DTM structure can record servo data with high efficiency by adopting a stamper manufacturing method including a pattern transfer step, without using a servo track writer. Such a recording method is sometimes referred to as discrete track recording (DTR). Specifically, by adopting DTR, servo data including a phase-difference servo burst pattern can be embedded with a high accuracy on a disk medium by a pattern transfer step.

In disk drives, disk runout due to attachment error of the disk to a spindle motor (SPM) occurs in disk medium having DTM structure or disk medium having a conventional structure. Further, in disk drives, the head is mounted on a rotary actuator, and moved under control to a designated position on a disk medium. Therefore, the head has a skew angle with respect to a designated position on the disk medium.

Disk drives require offset position adjustment to correct the displacement (offset position) of the head due to skew angle and eccentricity of the disk, when the head is brought into an on-track state (positioned to the center of the target track) in head positioning control. The offset position adjustment is operation to calculate a correction amount (offset amount) for correcting the displacement of the head and adjust the displacement of the head by the offset amount.

There has been proposed a positioning control method in which offset position adjustment is performed by calculating a first offset amount (DC offset amount) depending on the skew angle, and a second offset amount (DOC offset amount) depending on eccentricity of the disk (for example, refer to Jpn. Pat. Appln. KOKAI Pub. No. 2005-216378). This technique relates to, in particular, read DOC which performs correction (offset position adjustment) by DOC (dynamic offset control) when data is played back.

Since data tracks of disk medium having DTM structure are formed in advance, signals cannot be recorded in a desired position of the disk medium. Therefore, in head positioning control, it is necessary to accurately position the head in the center of a data track (discrete track) formed in advance.

Disk drives having disk medium with DTM structure are designed and manufactured such that the track center of the servo sectors corresponds to the center of data tracks. However, actually, it is not optimum to position the read head to the center of a servo track and play back recorded data from a data track. The bit error rate (BER) is further corrected by playing back data by slightly adjusting the offset position of the read head in accordance with the internal and external radial position. This is caused by gap distribution between the read/write heads and lateral displacement, and detection property of the servo burst position included in the servo data. Therefore, it is necessary to perform calibration of the optimum offset amount in data playback for each disk drive.

On the other hand, since there is change in skew angle of the head and gap between the read and write heads in data recording, the offset amount in recording changes also theoretically, depending on the radius position. Therefore, it is necessary to perform calibration of the optimum offset amount for each disk drive also in data recording.

In particular, in DTR, reduction in BER when servo data is played back by the read head in the internal side of disk medium depends on the position of the servo sector. Therefore, although the write head is positioned on the data tracks of the DTM structure as an average recording position of one rotation, the state where the write head is off the tracks in some parts occurs. This is because the skew angle varies during one rotation due to eccentricity of the disk, and thereby slight offset of the write head occurs.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram of a main part of a disk drive according to an embodiment of the present invention.

FIG. 2 is a block diagram of a main part of a head positioning control system according to the embodiment.

FIG. 3 is a block diagram of a main part of a target value generating unit according to the embodiment.

FIG. 4 is a block diagram for explaining function of a control processing unit according to the embodiment.

FIG. 5 is a flowchart for explaining process of optimum offset calibration according to the embodiment.

FIG. 6 is a diagram for illustrating a principle of generating a target value according to the embodiment.

FIG. 7 is a diagram for illustrating a principle of generating a target value in data recording according to the embodiment.

FIG. 8 is a diagram for illustrating relationship between an offset correction amount and primary RRO according to the present invention.

FIG. 9 is a diagram for illustrating relationship between an offset correction amount and primary RRO according to the present invention.

FIG. 10 is a diagram for illustrating a method of calculating an offset correction amount according to the embodiment.

FIG. 11 is a diagram for illustrating the method of calculating the offset correction amount according to the embodiment.

FIG. 12 is a diagram for illustrating relationship between an access radius and the offset correction amount according to the embodiment.

FIG. 13 is a diagram for illustrating relationship between an access radius and the offset correction amount according to the embodiment.

FIGS. 14A and 14B are diagrams for illustrating a determination method in optimum offset calibration according to the embodiment.

### DETAILED DESCRIPTION

Various embodiments according to the invention will be described hereinafter with reference to the accompanying drawings. In general, according to one embodiment of the invention, there is provided a disk drive having a disk medium having DTM structure, which can improve the head positioning accuracy in data recording.

(Structure of Disk Drive)

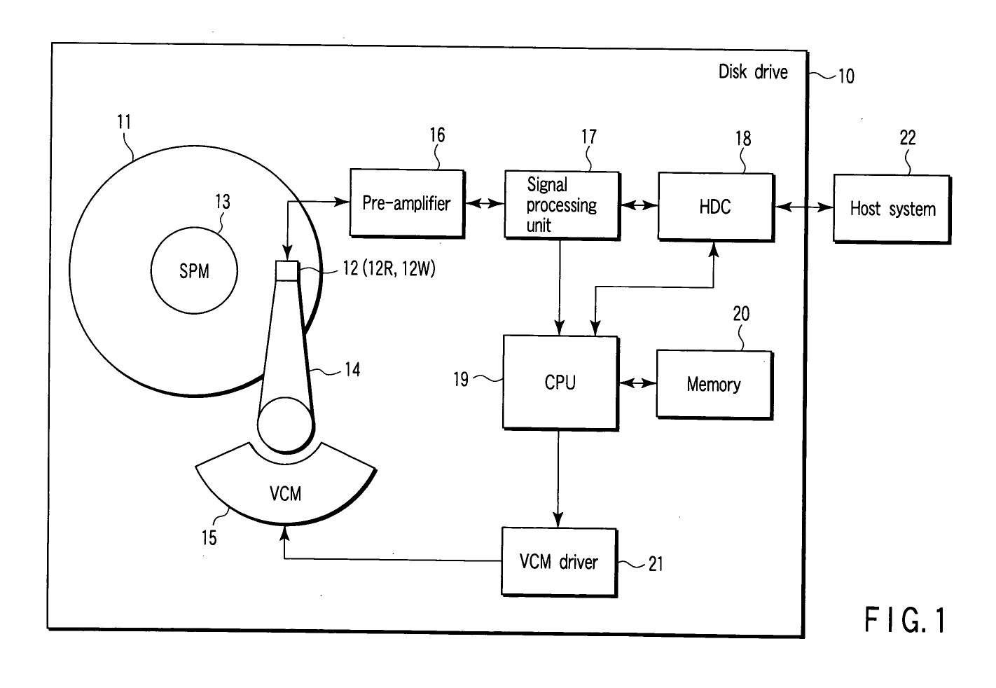

FIG. 1 is a block diagram illustrating a structure of a disk drive according to the embodiment of the present invention.

A disk drive 10 of the embodiment comprises a disk medium 11 having discrete track medium (DTM) structure, a head 12, a spindle motor (SPM) 13, and an actuator 14.

The disk medium 11 is a magnetic recording medium having a structure in which servo sectors recording servo data and data tracks being recording regions for user data are formed on a disk surface. The spindle motor (SPM) 13 holds and rotates the disk medium 11 at high speed.

The head 12 includes a read head 12R which reads data (servo data and user data) from the disk medium 11, and a write head 12W which writes data on the disk medium 11. The head 12 is mounted on the actuator 14 which is driven by a voice coil motor (VCM) 15. The VCM 15 is supplied with a drive current by a VCM driver 21, and thereby controlled and driven. The actuator 14 is a carriage mechanism which is driven and controlled by a microprocessor (CPU) 19 described below, and positions the head 12 to a target position (target track) on the disk medium 11.

In addition to the above head disk assembly, the disk drive 10 has a pre-amplifier 16, a signal processing unit 17, a disk controller (HDC) 18, a CPU 19, and a memory 20.

The pre-amplifier 16 has a read amplifier which amplifies read data signals output from the read head 12R of the head 12, and a write amplifier which supplies write data signals to the write head. Specifically, the write amplifier converts write data signals output from the signal processing unit 17 into write current signals, and transmits the signals to the write head.

The signal processing unit 17 is a unit which processes read/write signals, and also called as read/write channel. The read/write data signals include servo signals corresponding to servo data, as well as read/write signals of user data. The signal processing unit 17 includes a servo decoder which plays back servo data from servo signals.

The HDC 18 has a function of interface between the drive 10 and a host system (such as a personal computer and various digital apparatuses). The HDC 18 performs transfer control of read/write data between the disk 11 and the host system 22.

The CPU 19 is a main controller of the drive 10, and performs head positioning control according to this embodiment. Specifically, the CPU 19 controls the actuator 14 through the VCM driver 21, and thereby performs positioning control of the head 12. The memory 20 includes a RAM and a ROM besides a flash memory (EEPROM) being a nonvolatile memory, and stores various data and programs necessary for control by the CPU 19.

(Head Positioning Control System)

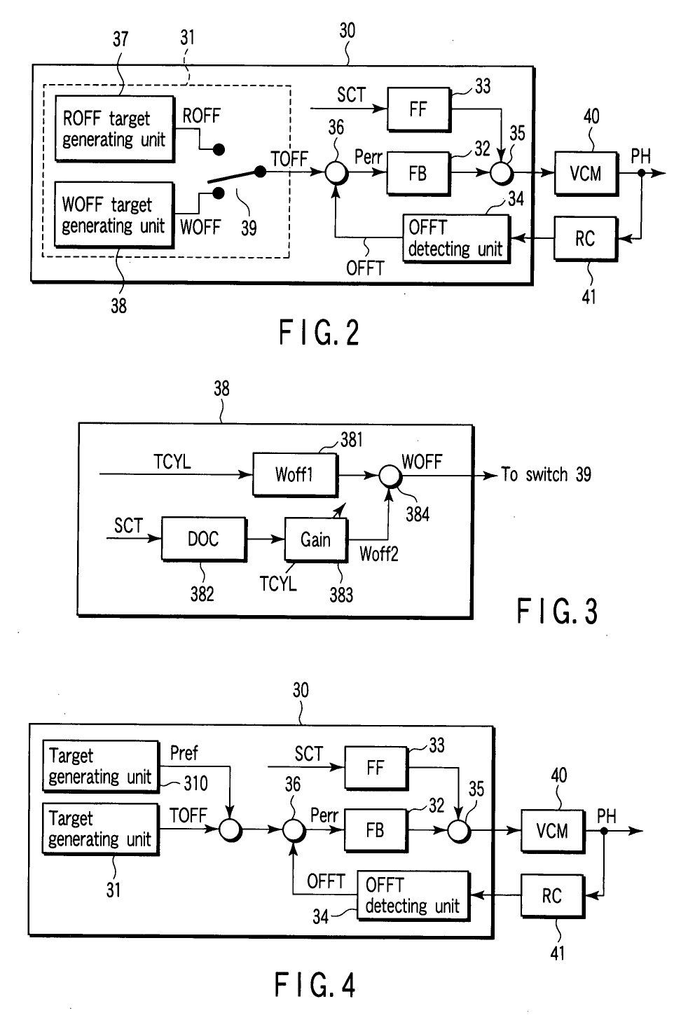

Next, a structure of a head positioning control system according to the embodiment is explained with reference to FIGS. 2 to 4. A control processing unit 30 being a main constituent element of the system comprises the CPU 19 and programs, and has the following function.

The system basically comprises the control processing unit 30, a head drive mechanism 40, and a position detecting unit 41. The head drive mechanism 40 is an actuator which drives the head 12 mounted thereon, and indicates the VCM 15 in a narrow sense. The position detecting unit 41 is an element which detects a relative position (head position) PH of the head 12 with respect to the disk medium 11. Specifically, the position detecting unit 41 is a read channel included in the signal processing unit 17.

The control processing unit 30 includes a target position generating unit 31, a feedback control unit 32, a feed forward control unit 33, an off-track detecting unit 34, a drive command generating unit 35, and a target position deviation detecting unit 36.

The off-track detecting unit 34 converts position information (servo data played back by the read head 12R) from the position detecting unit 41 into an off-track amount OFFT from a target position (the center of the data track). The target position deviation detecting unit 36 calculates deviation (position error) Perr between the off-track amount OFFT and a target offset amount TOFF generated by the target position generating unit 31. The feedback control unit 32 calculates a control amount to cancel the input deviation Perr.

The feed forward control unit 33 is a compensating unit which suppresses runout (RRO: repeatable runout) synchronizing with rotation of the disk medium 11, on the basis of the circumferential position SCT of the head 12 on the disk medium 11, and outputs an RRO compensation value (synchronization suppressing correction amount). The drive command generating unit 35 adds the output of the feed forward control unit 33 to the output of the feedback control unit 32, and thereby calculates a control value to control drive of the head drive mechanism 40.

The target position generating unit 31 has a playback target offset amount generating unit (ROFF target value generating unit) 37, a recording target offset amount generating unit (WOFF target value generating unit) 38, and a target offset amount selector switch (hereinafter simply referred to as “switch”) 39.

The ROFF target value generating unit 37 generates a target offset amount ROFF (a fixed value for each radius position) for a target value (track center) to position the head 12 when data is read. The WOFF target value generating unit 38 generates a target offset amount WOFF for a target value (track center) to position the head 12 when data is written. The switch 39 selects one of the ROFF or WOFF in accordance with whether data is read or written, and outputs the value as target offset amount TOFF to the target position deviation detecting unit 36.

As illustrated in FIG. 3, the WOFF target value generating unit 38 has a DC offset amount generating unit 381, a skew angle fluctuation estimating unit 382, an offset correction value generating unit 383, and an addition unit 384.

The DC offset amount generating unit 381 outputs an offset amount Woff1 depending on the radius based on the skew angle of the head 12. Specifically, the DC offset amount generating unit 381 generates a target offset amount Woff1 as a target offset amount which is estimated by interpolation from target track position information TCYL, on the basis of the optimum offset amount measured in a plurality of tracks in advance.

The skew angle fluctuation estimating unit 382 estimates a skew angle of the head 12 caused by track deviation fluctuations, depending on the circumferential position SCT. The offset correction value generating unit 383 generates a target offset amount Woff2 for a target track position information TCYL, in consideration of fluctuations of the skew angle estimated by the skew angle fluctuation estimating unit 382. The addition unit 384 outputs a result of addition of the target offset amount Woff1 and the target offset amount Woff2 as recording target offset amount WOFF.

(Operation of the Head Positioning Control)

First, head positioning control of the disk drive is control processing to position the read head 12R with respect to tracks, by using servo data read from the disk medium 11 by the read head 12R. Therefore, the target position generating unit 31 outputs information indicating to what extent the read head 12R is subjected to off-track correction (offset position adjustment) with respect to the target track center.

In disk drives having a disk medium of conventional structure, there are no physical data tracks on the disk medium when the products are shipped. Servo tracks based on servo sectors recording servo data are formed on the disk medium. Therefore, the disk drives performs positioning control of the read head with respect to a target servo track on the disk medium in data recording, and thereby data tracks are formed in desired positions by the write head positioned thereby.

Specifically, in data recording, since the read head is controlled to be positioned in the center of the target servo track, the target offset amount WOFF output from the WOFF target value generating unit 38 is always set to zero. When data is written, the switch 39 outputs the target offset amount WOFF from the generating unit 38 as target offset amount TOFF.

In the disk drive 10, the head 12 has a structure in which the read head 12R is separated from the write head 12W. Therefore, there is a gap of about 2 to 6 μm between head elements of the read head 12R and the write head 12W. Further, since the head drive mechanism 40 has an actuator of rotation drive type, the access angle of the drive mechanism varies according to the radium position to which the head is positioned. Therefore, an angle called skew angle is made between the running direction of the track and the center line of the head.

Since there are the gap between the read/write heads and the skew angle, centers of the data tracks do not coincide with the centers of the servo tracks, but are formed outside the centers of the servo tracks on the external periphery side, and formed inside the centers of the servo tracks on the internal periphery side. Therefore, when data is played back, the target offset amount TOFF is provided to correct the track shift amount between the data tracks and the servo tracks which occurs in data recording, such that the read head is positioned to the center of the data tracks.

With reference to FIG. 2, when data is played back, the ROFF target value generating unit 37 generates a target offset amount ROFF to correct the track shift amount. When data is played back, the switch 39 outputs the target offset amount ROFF from the generating unit 37 as target offset amount TOFF.

Ideally, the target offset amount ROFF in data playback is physically uniquely determined, on the basis of the radial position determined by the track position CYL, the position of the rotation center (pivot) of the actuator, and the distance between the pivot and the head. However, actually, there are angle displacement due to the head attachment tolerance, variations of the gap between the read/write head elements, and lateral displacement between the head elements. Thereby, even when the target offset mount TOFF is set as the ideal theoretical value, the read head cannot be always positioned to the center of the data track.

Actually, the optimum offset amount in a plurality of tracks is measured for each disk drive in advance, the optimum offset amount is subjected to estimation and interpolation based on the positioning track information CYL, and thereby the target offset amount ROFF is output. Further, the optimum offset amount is obtained as follows. The target offset amount TOFF is varied around the offset amount of an ideal theoretical value in a plurality of calibration track positions, and change of the bit error rate (BER) of a playback signal according to the offset position is monitored. Then, the offset amount in which BER has a minimum value is determined as the optimum offset amount.

On the other hand, the disk drive 10 of the embodiment uses the disk medium 11 having DTM structure, as described above. Therefore, when the product is shipped, data tracks are formed in advance on the disk medium 11. The data tracks are arranged in positions having almost the same offset (generally, 0) as that of the servo tracks, regardless of the radial position of the disk medium.

Therefore, in data recording, it is necessary to position the write head 12W on the data tracks formed in advance, in the state where the read head 12R is offset. Specifically, as described above, the DC offset amount generating unit 381 generates an offset amount Woff1 as target offset amount estimated and interpolated based on the target track position information TCYL. This processing is almost the same as the processing of the target offset amount generating unit 37 in data playback.

On the other hand, the WOFF target value generating unit 38 generates a recording offset amount Woff2 for the target track position information TCYL, which depends on the circumferential position SCT, in consideration of fluctuations of the skew angle. Then, the addition unit 384 outputs a result of addition of the offset amount Woff1 and the recording offset amount Woff2 as a data recording target offset amount Woff.

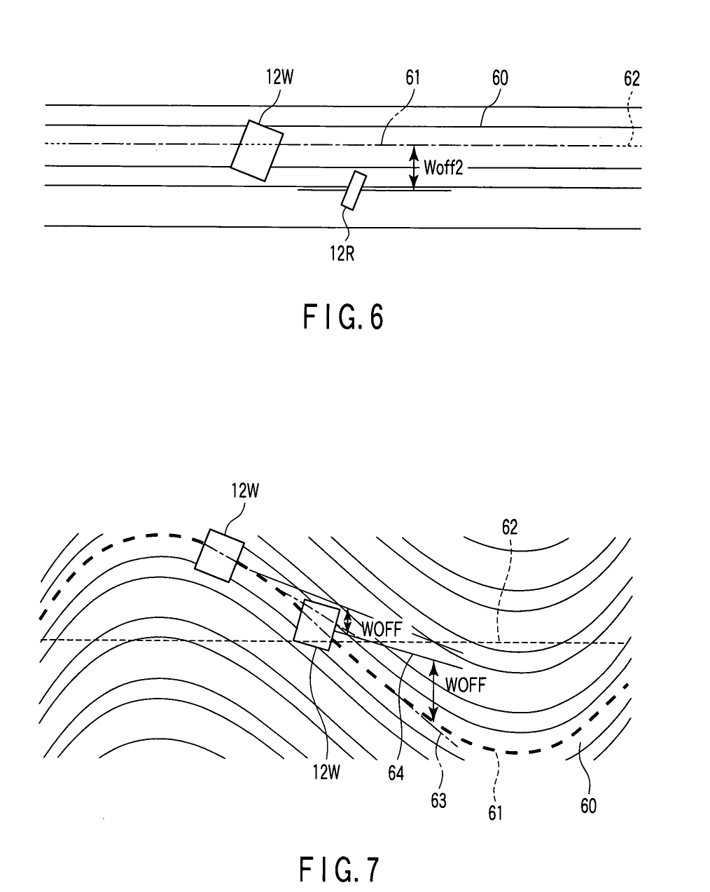

The principle of the WOFF target value generating unit 38 is explained below with reference to FIGS. 6 and 7.

FIG. 6 is a diagram illustrating an ideal state in which a data track 60 of DTM structure is formed in an almost perfect concentric state on the disk medium 11, and the center of rotation of the disk medium 11 exactly coincides with the center of the data track 60. In this case, the output Woff1 of the DC offset generating unit 381 can be used as it is as the target offset amount WOFF in data recording, as described above.

However, actually, there are eccentricity when the disk medium 11 is attached and center positioning error when DTM is formed. Therefore, as shown in FIG. 7, the circumferential position of the data track 60 having DTM structure varies in the radial direction. The servo track (the track of the center line 61) itself is also distorted in the same form as the data track 60. Therefore, it seems that the above DC offset Woff1 itself can be used as the target offset amount for the servo position. However, actually, using Woff1 as the recording target offset amount TOFF causes a problem that data is not accurately recorded in some data sectors. It is considered that this is because the skew angle changes due to fluctuations of the position of the track in the radial direction fluctuations of the track running direction line. Since the skew angle varies according to the circumferential direction (of the track), the optimum offset amount in the position of the element of the read head 12R which is distant by the gap between the read/write head elements also changes accordingly.

FIG. 7 illustrates the skew angle and the optimum offset amount WOFF in two different radial positions. A long and short dashed line 63 denotes a track running direction tangent line, and a thin line 64 denotes a head access angle. An angle made between the lines 63 and 64 is the skew angle. Further, since the optimum offset amount is a distance to a track running direction tangent line (servo track) in a position distant by the gap between elements, it is necessary to change the optimum recording offset in dependence on the recording sector position.

However, in FIG. 7, the data recording target offset amount WOFF is not properly drawn. Specifically, although the target offset amount WOFF corresponds to the offset amount of the write head 12W on the track from the read head 12R on the track, the offset amount WOFF in FIG. 7 does not seems to be a distance from the on-track. This is caused by contradiction on the drawing scale. FIG. 7 illustrates one rotation of the track with the circumferential direction thereof set to the lateral axis. The gap between the read/write head elements is 1 to 10 μm, while the circumferential direction has a distance ten thousands as long as the gap, and thus the above improper drawing is obtained.

Further, although the position of the read head 12R is omitted in FIG. 7, since the gap amount between the read/write head elements are drawn with huge dimensions, the target offset amount WOFF does not seem to be the distance between the read head 12R to the servo track. If it is drawn with an actual scale, the target offset amount WOFF is equal to the distance between the read head 12R to the servo track. The amplitude of the target offset correction amount Woff2 depending on the servo sector is almost proportional to the track change amount or the recording radial position. Therefore, if the attachment eccentricity of the disk medium 11 does not change, as the radius becomes smaller, the influence thereof becomes larger. In particular, in the disk drive 10 with a small size, the target offset correction amount fluctuates with a range of ±20% or more of the track pitch at the internal side of the disk medium, and it is indispensable to perform correction.

In short, it is necessary to vary the target offset correction amount Woff2 depending on the servo sector, for each servo sector. Without varying the target offset correction amount Woff2, it is difficult to perform accurate data recording on data tracks of DTM structure at the internal side of the disk medium 11, and reduction in BER in some parts in data playback is caused.

(Method of Determining the Offset Correction Amount Woff2)

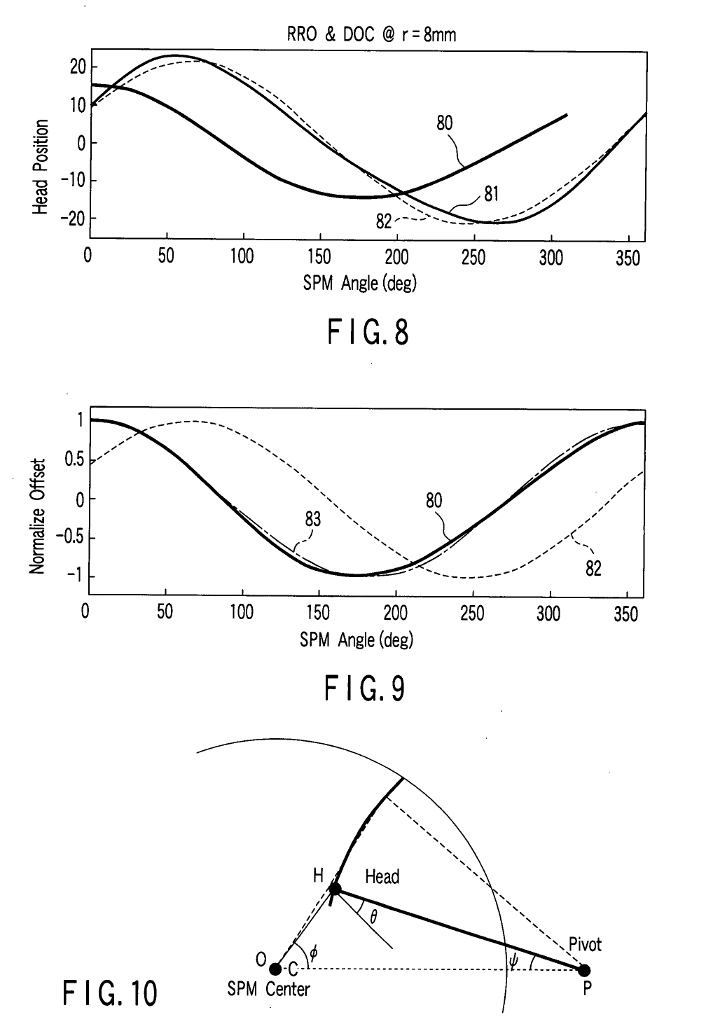

A method of determining the offset correction amount Woff2 depending on the servo sector as offset correction amount in data recording is explained below with reference to FIGS. 8 to 13.

With respect to the offset amount in data recording, the following approximate relationship represented by the expression (1) is obtained, supposing that an ideal skew angle is θ, a skew angle fluctuation amount is Δθ, and gap between the read/write head elements is Lg.

$$\begin{matrix}WOFF = {L}_{g} \cdot sin ( θ + Δθ ) ≅ {L}_{g} ( sin θ + cos θ \cdot Δθ ) \\ = {L}_{g} sin θ + k ( R ) \cdot Δθ = Woff 1 + Woff 2\end{matrix} \qquad ( 1 )$$

The fluctuations of the skew angle can be estimated from the expression (1), and thereby the offset correction amount Woff2 can be calculated by correction of proportional multiplication thereof. Although processing of obtaining the track radial direction change amount ΔR for the purpose of suppressing synchronization is publicly known, the skew angle fluctuation amount Δθ does not always have a proportional relationship with the primary eccentricity amount. This relationship is explained below with reference to FIGS. 10 and 11.

FIG. 10 illustrates relationship between the rotation center O of the SPM 13 in the disk drive 10, the arm rotation P (Pivot) of the actuator 14 of the head drive mechanism, and the head position H. Actually, the track center C is located in a position shifted from the rotation center O of the SPM 13 by the amount of the track eccentricity. In this scale, the track center C is almost superposed on the rotation center C, and it seems that C coincides with O. In this state, if the radius R (CH=R) of the track is determined, the shape of a triangle CPH is uniquely determined. In FIG. 10, for simplify the explanation, an inline angle which is generated when the access system has a dogleg shape or the like is disregarded. In this case, an angle formed by the normal of CH and PH is a skew angle θ. The skew angle θ is calculated by the following expression (2).

θ=180−(φ+φ)−90=90−(φ+φ) (2)

FIG. 11 is a diagram in which eccentricity is exaggerated, since ΔR and Δθ cannot be seen in FIG. 10. Reference symbol C in FIG. 11 is the track center which rotates around the rotation center O of the SPM 13, and thereby the shape of the triangle CPH slightly changes. The track radial direction change amount ΔR is detected as a value obtained by multiplying a change amount Δψ of the angle OPH by the arm length PH of the actuator 14. The peak of the detection eccentricity appears at a phase angle in which OH has a largest value.

On the other hand, the skew angle fluctuation amount Δθ is equivalent to the change amount of angle HCP φ+the angle OPH ψ by the above expression (2). As R becomes smaller, change of the angle HCP φ becomes more dominant. DOC has a maximum value when C is located on line OP. Although it is difficult to understand from FIG. 11 having exaggerated illustration, the actual shape is as illustrated in FIG. 10, and thus change of the skew angle appears in the angle HOP earlier than the peak of the eccentricity.

FIGS. 8 and 9 are diagrams illustrating the relationship between the offset correction amount Woff2 depending on the servo sector and the track displacement being a primary RRO eccentricity.

FIG. 8 is a diagram illustrating relationship between the RRO correction amount (81) for synchronization suppression and the optimum offset correction amount Woff2 (80). A dotted line 82 corresponds to a primary component of track displacement, that is, track eccentricity.

In FIG. 9, the sine wave amplitude is normalized to 1, and a broken line denotes a component obtained by advancing a primary component 83 of the track displacement (RRO correction amount) by 66.7234 degree corresponding to the angle HOP. Specifically, the broken line 83 is a primary component of the RRO correction amount advanced by a geometric phase.

Estimation of the skew angle fluctuations is possible by advancing the primary eccentricity component of the correction amount of synchronization suppression by an amount corresponding to the angle HOP which is determined by mechanism arrangement of the drive 10. The estimated value 83 denoted by the broken line does not necessarily coincide with the offset correction around Woff2 denoted by the solid line 80. This is because the optimum offset correction amount Woff2 is distorted from the sine wave, due to RRO distortion of components other than primary component of the track displacement, that is, secondary components. In this embodiment, estimation based on primary components is performed for simply estimating the skew angle fluctuations. However, correction may be performed in consideration of secondary and tertiary components. Strictly, the angle HOP varies according to the access track position. However, since the change of the angle HOP is small, sufficient estimation is performed by advancing the primary eccentricity component of the correction amount of the synchronization suppression by a certain angle.

Next, the amplitude of the offset correction amount Woff2 to be corrected is a change amount of the expression (2), and corresponds to the change amount of angle HCP φ+angle OPH φ, and thus analysis thereof is complicated. However, the amplitude can be approximately regarded as change of the angle HCP, and as being inversely proportional to the access radius R of H, if the change of eccentricity of C is fixed.

Specifically, the amplitude can be approximately calculated as shown in the following expression (3), by multiplying the reciprocal gain Gain (R) according to the radial position calculated from the data track to be accessed by an estimation amount obtained by correcting the primary eccentricity ΔR by the phase angle.

$$\begin{matrix}WOFF = {L}_{g} \cdot sin ( θ + Δ θ ) \\ ≅ Woff 1 + k ( R ) \cdot Δ θ \\ ≅ Woff 1 + k ( R ) \cdot \frac{T \cdot Δ R}{R} \\ = Woff 1 + Gain ( R ) \cdot T \cdot Δ R\end{matrix} \qquad ( 3 )$$

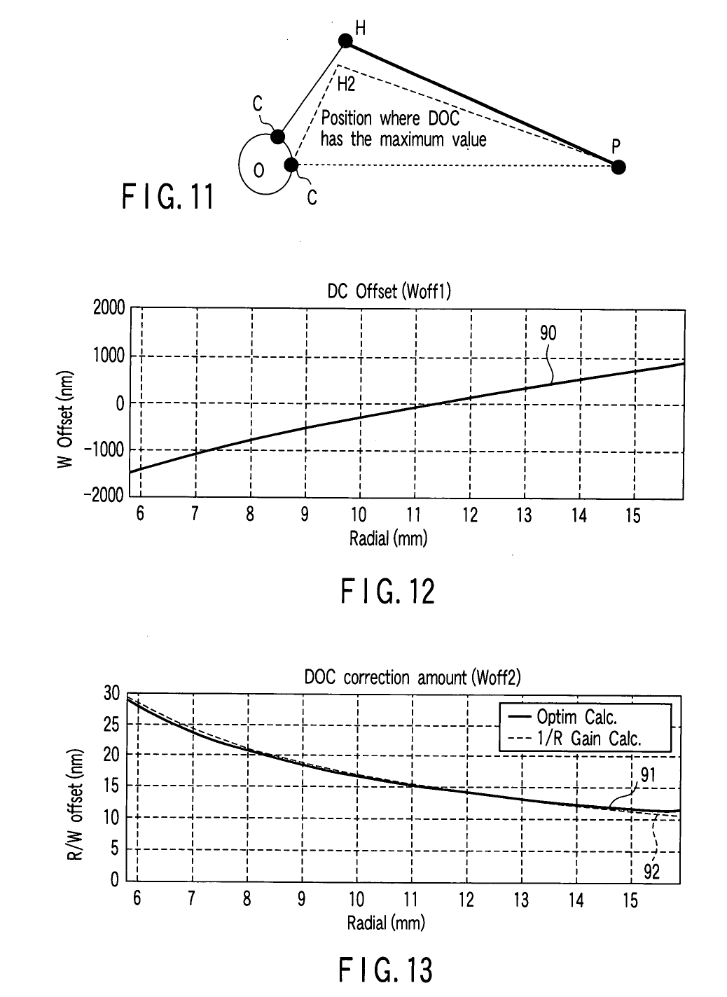

FIGS. 12 and 13 are diagrams illustrating validity of approximate calculation result obtained by the expression (3). Specifically, FIG. 12 illustrates a characteristic 90 of the DC component offset correction amount Woff1 depending on the skew angle in data recording. FIG. 13 is a diagram illustrating a sine wave amplitude 91 of the offset correction amount Woff2 for each servo sector. In FIG. 13, a broken line 92 denotes a simply estimated amplitude obtained by multiplying the eccentricity primary amplitude by an amplitude gain (R) which is inversely proportional to the radial position. Specifically, FIG. 13 illustrates a simply calculated correction amount based on the reciprocal gain according to the radial position. Although error is large in internal and external peripheral portions on the disk medium 11 since the amount is an approximate value, a relatively correct amplitude is obtained.

(Operation of the Target Position Generating Unit 31)

Operation of the target position generating unit 31 is explained with reference to FIGS. 2 and 3 again.

In data recording, the target position generating unit 31 outputs the target offset amount WOFF output from the WOFF target value generating unit 38 as the target value TOFF. Further, in data playback, the target position generating unit 31 outputs the target offset amount ROFF output from the ROFF target value generating unit 37 as the target value TOFF.

As illustrated in FIG. 3, In the WOFF target value generating unit 38, the DC offset amount generating unit 381 generates the offset correction amount Woff1 depending on the radius, which is estimated by interpolation from the target track position information TCYL. Further, in the WOFF target value generating unit 38, the offset correction value generating unit 383 generates an offset correction amount Woff2 for the target track position information TCYL in consideration of fluctuations of the skew angle estimated by the skew angle fluctuation estimating unit 382. The addition unit 384 outputs a result of addition of the offset correction amount Woff1 and the offset correction amount Woff2 as the target offset amount WOFF.

The DC offset amount generating unit 381 estimates by interpolation of a desired target track position information TCYL by performing linear interpolation of an optimum value calibrated in advance in a plurality of tracks, and outputs an offset correction amount Woff1 dependent on the radius.

On the other hand, the skew angle fluctuation estimating unit 382 estimates an amount of fluctuation Δθ from an ideal skew angle θ. By the above principle, the skew angle fluctuation estimating unit 382 advances a primary eccentricity component of the change amount ΔR in the radial direction of the track by a certain phase angle, and then outputs a resultant value. The offset correction value generating unit 383 outputs an offset correction amount Woff2 obtained by multiplying the fluctuations of the skew angle by a gain which is inversely proportional to the radius.

The skew angle fluctuation estimating unit 382 outputs a signal obtained by advancing the change amount ΔR in the radial direction of the track by a proper phase set amount, on the basis of synchronization suppressing information estimated by the feed forward control unit 33 (rotation synchronization fluctuation suppressing compensator).

Various methods can be adopted for the feed forward control unit 33. The feed forward control unit 33 also performs compensation of high-order synchronization components besides low-order components. In this example, primary eccentricity is estimated as sine and cosine coefficients A and B by DFT. In this case, the synchronization component compensation amount of the primary eccentricity in the feed forward control unit 33 can be calculated by the following expression (4).

$${U}_{FF 1} ( k ) = {G}_{1} \cdot [ {A}_{1} \cdot sin ( \frac{2 π}{N} k ) + {B}_{1} \cdot cos ( \frac{2 π}{N} k ) ] \qquad ( 4 )$$

Numerical subscripts A and B in the expression indicate estimated coefficients of primary components. G is a gain coefficient depending on the order of control output conversion. N is the number of servo sectors. K is a servo sector number, which has a value of 1 to N in one rotation.

The offset correction value generating unit 383 refers to A₁ and B₁ estimated at present, and generates a sine wave signal obtained by advancing A₁ and B₁ by a proper phase angle by using the following expression (5).

$$DOC ( k ) = {A}_{1} \cdot sin \{ \frac{2 π}{N} ( k - H ) \} + {B}_{1} \cdot cos \{ \frac{2 π}{N} ( k - H ) \} \qquad ( 5 )$$

H in the above expression is a pointer correction value corresponding to the above fixed lead phase angle. If N is 120° and the lead angle is 66.7234 deg, H is 22.24. In this case, 22 is adopted as the value of H as a positive integer. Actual phase lead processing is achieved by referring to sine and cosine values which are earlier than k by H, when referring to the table of Sin and Cos.

The offset correction value generating unit 383 obtains a coefficient Gain depending on the radius based on the target track TCLY, on the basis of the change amount ΔR in the radial direction of the track, and calculates the offset correction amount Woff2 by multiplying the coefficient Gain by the DOC value of the expression (5). By the above processing, it is possible to position the write head 12R on each data track and record data through the whole circumference of the disk medium 11 of DTM structure.

Next, when data is played back, the ROFF target value generating unit 37 outputs a target offset amount ROFF as the target value TOFF. As described above, in the disk medium 11 of DTM structure, the centers of the data tracks and the centers of the servo tracks are formed to be offset from each other with a fixed value. Therefore, by forming the tracks with the offset set to 0, the offset target value ROFF can be set to 0 on principle without depending on the radius.

However, actually, the target offset amount ROFF slightly fluctuates in the internal and external radius positions of the disk medium 11. This is because the detecting side detects the offset center with an apparent offset from the originally intended center of the servo track. The apparent offset average fluctuations correlate with the skew angle.

Therefore, in this embodiment, an optimum offset is estimated in advance in a plurality of tracks also for the target offset amount ROFF, and outputs the ROFF estimated by interpolation using the optimum offset with the target track TCLY. Since the apparent offset change is small, the above processing is not indispensable. The target offset amount ROFF in data playback can be set to a fixed value, regardless of the position (internal or external radius side) of the track on the disk medium 11.

(Method of Measuring the Optimum Offset)

Further, a method of measuring the optimum offset according to the embodiment is explained with reference to FIGS. 4, 5 and 14.

In optimum offset measuring methods generally performed, an offset amount having a minimum BER is determined on the basis of offset BER measurement. In this case, it is required that data is accurately recorded to enable the optimum offset measurement.

However, in the DTR (discrete track recording) method relating to the embodiment, that is, a recording method of recording servo data on a disk medium of DTM structure, the precondition that data is accurately recorded is not satisfied. Even if data is recorded with a target offset amount WOFF being a theoretical value calculated from the target track, on-track recording cannot be performed in almost all the cases, and BER in data playback cannot be measured.

Therefore, the optimum offset measuring method of the embodiment is applied to the DTR method, and the optimum offsets (offset positions) for both recording and playback are measured in a short time from one signal recording. The method is specifically explained below.

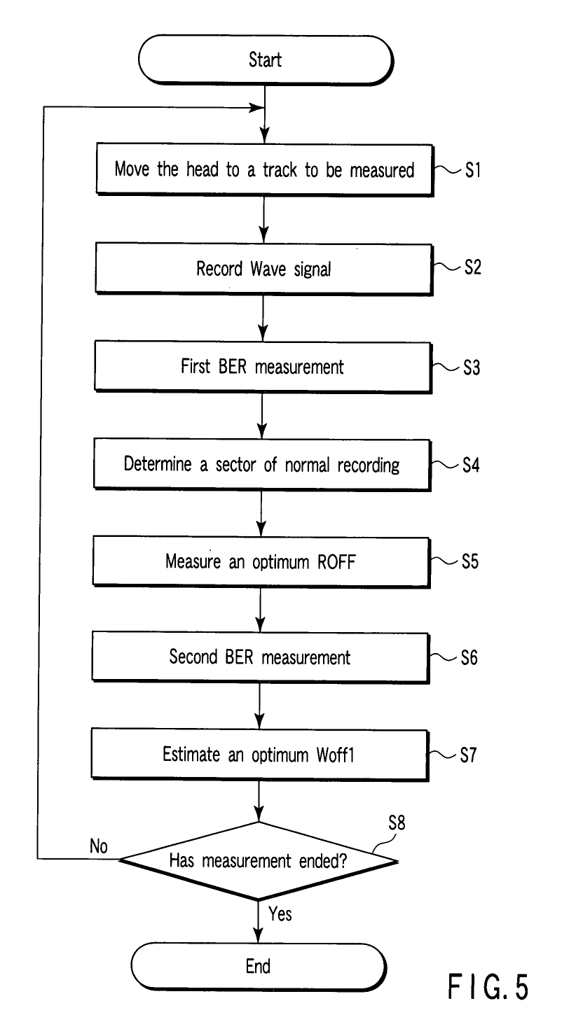

The optimum offset calibration process of the embodiment is illustrated in FIG. 5. First, the head 12 is moved to a track to be measured, and Wave signal is recorded by the write head 12W (Blocks S1 and S2). Then, data is played back by the read head 12R from sectors of the track, and a bit error rate (BER) is measured (Block S3). On the basis of a result of BER measurement, a sector which normally recorded data is determined (Blocks S4).

Then, an optimum target offset amount ROFF limited to the sector which normally recorded data is measured (Block S5). Then, data playback is performed with the target offset amount ROFF, and BER is measured (Block S6). Based on the measurement result, an optimum offset correction amount Woff1 is estimated (Block S7). This measurement is repeated for all the tracks on the disk medium 11 (Block S8).

In the above optimum offset calibration process, the Wave recording in Block S2 is a process of recording random data by varying the positioning target value to the internal and the external periphery sides on the disk medium 11. However, the Wave recording method of the embodiment has a small recording amplitude, and Wave recording is performed in the state where the recording target offset amount TOFF is input as illustrated in FIG. 4.

FIG. 4 is a diagram for illustrating function of the control processing unit 30 when Wave recording is performed in the optimum offset calibration.

The offset target generating unit 310 for Wave recording outputs a target offset amount Pref for further offset change of the head position, on the basis of the current servo sector SCT. Specifically, the offset target generating unit 310 generates a target offset amount Pref which varies for each servo sector. The target generating unit 310 becomes effective by a command in the manufacturing process of the disk drive 10.

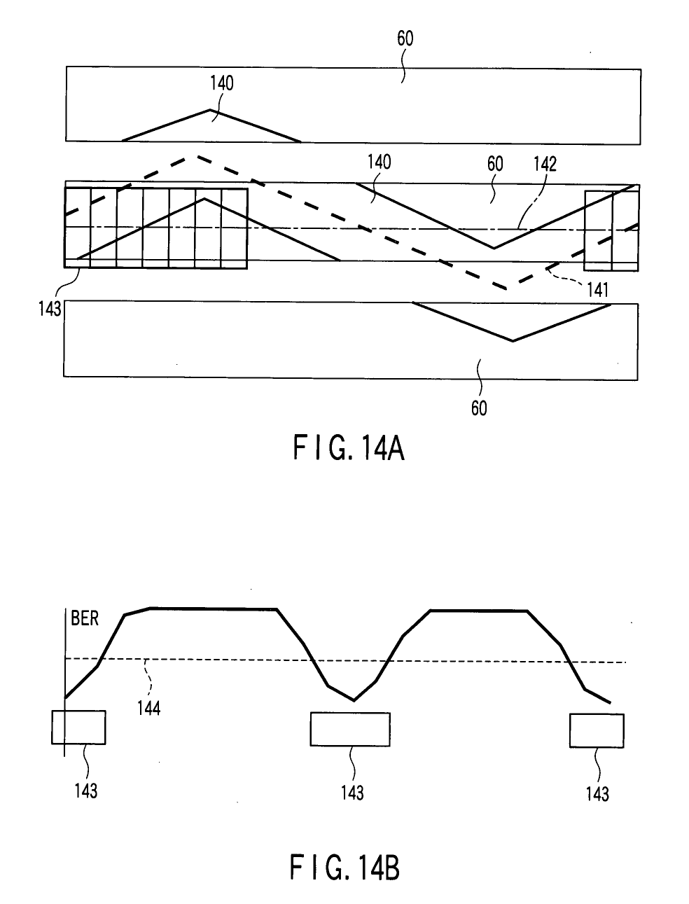

FIG. 14A illustrates a recorded image by the Wave recording. In this example, the recording amplitude is an amplitude with ±1 track pitch, and has a triangular pattern of crests and troughs which uniformly increases and decreases in a linear shape. However, the Wave recording target is not limited to triangular pattern of crests and troughs, but may be an offset command having a sine wave shape.

The control processing unit 30 positions the head 12 to an offset position obtained by adding the target offset amount Pref and the above recording offset correction amount WOFF (TOFF). However, in the recording offset correction amount WOFF, Woff1 which is a recording DC offset amount is not determined at this point in time, although the offset correction amount Woff2 is determined without prior calibration. Before the optimum offset calibration, a theoretical calculation value which is initially set to the system (CPU 19) is used as Woff1.

Further, the disk drive 10 of the embodiment includes a function that write operation by the write head 12W is prohibited for safety if the track (cylinder) in measurement is different from the positioning target track. In this case, in Wave recording, the function of prohibiting write operation is disabled, and Wave recording of a random data signal is performed without a write error.

Since the tracks of the disk medium 11 having DTM structure are separated by non-magnetic regions, signal recording cannot be performed in the state where the write head 12W is located in non-magnetic portions. Actually, data which can be accurately played back cannot be recorded in the state where a part of the write head 12W is located on a data track.

FIG. 14A illustrates a data recording region 140 which is recorded by the write head 12W on the data track 60. FIG. 14A also illustrates a passing trail 141 of the write head 12W, and a passing trail 142 of the read head 12R when data is played back from the data recording region 140.

When data is played back, since the optimum target offset amount ROFF in the ROFF target value generating unit 37 has not been determined yet, the DC offset amount designed in manufacturing the disk medium 11 of DTM structure is output as the target value TOFF. Therefore, signal is played back by the read head 12R in a position which is slightly shifted from the exact offset center.

As illustrated in FIG. 5, in the optimum offset calibration process, measurement of BER of sectors (first BER measurement) is performed when data is played back by the read head 12R (Block S3). Based on the BER measurement result, a sector in which data was normally recorded is determined (Block S4).

The BER measurement is not general BER measurement for the whole tracks, but BER measurement performed by multiplying playback results of a plurality of rotations for each block containing a plurality of data sectors. FIG. 14B illustrates an image of BER measurement results for blocks. A block 143 indicates a data block in sector BER measurement.

As illustrated in FIG. 14B, passing block groups whose BER measurement result exceeds a playback pass standard 144 always appears in one or two parts in one rotation. FIG. 14B illustrates blocks 143 as passing sector groups of the BER measurement result, as circumferential measurement image. The regions 143 are determined as circumferential positions which are determined as regions where data are accurately recorded. Specifically, it is indicated that offset BER measurement being a conventional playback offset estimation method having high accuracy can be performed in these parts.

Therefore, offset BER measurement is performed only in the passing sectors where data was normally recorded, and the optimum playback offset amount ROFF is measured (Blocks S5). In this embodiment, BER for each offset is measured by using a BER measurement range set by removing front and rear several sectors from sectors of the region where the most passing block groups continues. Offset BER measurement may be performed by using all the passing sectors. Publicly known methods can be used as a method of obtaining the optimum playback offset amount from the offset BER measurement result.

By the above processing, a complete on-track playback can be performed in the calibrated track. Therefore, as described above, BER measurement of the sectors (second BER measurement) is performed again (Blocks S6). The second BER measurement is different from the first BER measurement in that on-track playback is performed with an optimum playback offset amount ROFF, the circumferential resolution is improved by setting the smaller number of BER measurement blocks, the rotation numbers are increased accordingly, and BER measurement accuracy is improved by performing BER measurement a plurality of times and using an average BER of each sector as BER of the sector.

Based on the measurement result of the second BER measurement, an optimum recording offset amount Woff1 is estimated (Block S7). The estimation method is performed by obtaining a ratio of intervals at which BER has the minimum value. Specifically, in intervals at which BER has the minimum value, the first interval is longer than the latter interval. Since the interval at which BER has a minimum value indicates an on-track state, the first interval indicates a rate of a state of shifting from the track to the upper side, and the latter interval indicates a rate of state of shifting from the track to the upper side. The ratio of the intervals shows an actual error from the offset amount Woff1 being the initial theoretical calculation value. Specifically, supposing that BER minimum intervals are S1 and S2, and the amplitude (Tp) in Wave recording is W_{WAVE}, the optimum recording offset amount is obtained by the following expression (6).

$$Woff {1}_{OPT} = Woff {1}_{0} + ( \frac{2 \cdot S 1}{S 1 + S 2} ) - 1 {W}_{WAVE} \qquad ( 6 )$$

By the above process, the optimum playback offset amount and the optimum recording offset amount in a calibrated track can be obtained by only playing back one test recording a plurality of times. Then, it suffices to obtain an optimum offset amount for each track in a plurality of calibration designated tracks. The optimum results of the tracks are transferred to and recorded on a flask ROM included in the memory 20 of the drive 10 by a manufacturing command. Thereafter, as described above, the optimum offset amount is referred to from the flash ROM, an optimum offset amount in a desired track is calculated by interpolation approximation, and thereby the optimum offset amount is always set.

As described above, according to the above embodiment of the present invention, head positioning control is performed in a disk drive using the disk medium 11 of DTM structure, on the basis of the target offset amount WOFF obtained by adding the first offset amount Woff1 (DC offset amount) depending on the skew angle and the second offset correction amount Woff2 (DOC offset amount) set for each servo sector, in particular, in data recording. Therefore, the head positioning accuracy in data recording is improved. Specifically, in data recording, data can be accurately recorded, by positioning the write head 12W on the data track formed on the disk medium 11 in advance. Thereby, when data is played back, recorded data is accurately played back by the read head 12R. This structure provides a disk drive using the disk medium 11 having DTM structure, with excellent recording and playback performance.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a disk medium in which servo sectors recording servo data and data tracks are formed on a disk surface;
a head having a write head which records data on the disk medium, and a read head which plays back data from the disk medium;
an actuator on which the head is mounted, the head positioning the head to a designated position on the disk medium; and
a control unit which performs positioning control to position the write head on a designated data track on the disk medium by using the servo data read by the read head, the control unit performing the positioning control in accordance with a recording target offset amount calculated by adding a first offset amount depending on a skew angle of the head and a second offset amount set as an offset correction amount for each of the servo sectors, when the positioning control is performed to position the write head on the data track.

2. The disk drive according to claim 1, wherein
the control unit performs the positioning control in accordance with a playback target offset amount being a fixed value depending on the skew angle of the head, when the positioning control is performed to position the read head on the data track.

3. The disk drive according to claim 1, wherein
the control unit includes a unit which calculates the second offset amount, and
the unit calculates the second offset amount by multiplying an offset correction value by a reciprocal gain set in accordance with a radial position in which the head is positioned on the disk medium, the offset correction value is obtained by shifting a primary component of a synchronization suppressing correction amount to suppress a rotation synchronization component of the disk medium by a phase angle calculated based on a position relationship between a rotation center of the disk medium and the head mounted on the actuator.

4. The disk drive according to claim 1, wherein
the control unit includes:
a unit which detects an offset amount of the head with respect to a target data track in data recording;
a unit which calculates a deviation of the offset amount from the recording target offset amount; and
a unit which cancels the deviation and drives and controls the actuator such that the head is positioned on the target data track.

5. The disk drive according to claim 1, wherein
the control unit includes a generating unit which calculates the recording target offset amount in data recording, and
the generating unit includes:
a unit which calculates the first offset amount which is estimated by interpolation from target position information of the head, based on an optimum offset amount measured in advance; and
a unit which calculates the second offset amount from the target position information of the head, based on an estimation result of fluctuations of the skew angle of the head corresponding to the servo sector.

6. The disk drive according to claim 1, wherein
the control unit includes:
a unit which generates the recording target offset amount to perform positioning control to position the read head on the data track in data playback;
a unit which detects an offset amount of the head with respect to a target data track;
a unit which calculates a deviation of the offset amount from a target offset amount;
a unit which cancels the deviation and drives and controls the actuator such that the head is positioned on the target data track; and
a unit which selects the recording target offset amount as the target offset amount in data playback, and selects the recording target offset amount as the target offset amount in data recording.

7. A head positioning control method applied to a disk drive, the disk drive having a disk medium in which servo sectors recording servo data and data tracks are formed on a disk surface, a head having a write head which records data on the disk medium, and a read head which plays back data from the disk medium, and an actuator on which the head is mounted, the head positioning the head to a designated position on the disk medium,
the method comprising:
performing positioning control to position the write head on a designated data track on the disk medium in data recording, by using the servo data read by the read head;
calculating a first offset amount depending on a skew angle of the head;
calculating a second offset amount which is set as an offset correction amount for each of the servo sectors;
calculating a recording target offset amount by adding the first offset amount and the second offset amount; and
performing the positioning control in accordance with the recording target offset amount.

8. The method according to claim 7, further comprising:
performing the positioning control in accordance with a recording target offset value being a fixed value depending on the skew angle of the head, when the positioning control is performed on position the read head on the data track in data playback.

9. The method according to claim 7, further comprising:
detecting an offset amount of the head with respect to a target data track;
calculating a deviation of the offset amount from the recording target offset amount; and
canceling the deviation and driving and controlling the actuator such that the head is positioned on the target data track.

10. The method according to claim 7, further comprising:
generating a playback target offset amount to perform positioning control to position the read head on the data track in data playback;
detecting an offset amount of the head with respect to a target data track;
calculating a deviation of the offset amount from the target offset amount;
canceling the deviation and driving and controlling the actuator such that the head is positioned on the target data track; and
selecting the recording target offset amount as the target offset amount in data playback, and selecting the recording target offset amount as the target offset amount in data recording.
